(19) United States
(12) Patent Application Publication
(10) Pub. No.: US 2003/0070926 A1
(43) Pub. Date: Apr. 17, 2003

(54) Landmarks and use thereof

(76) Inventors: Ola Forsstrom-Olsson, Lund (SE); Anders Johan Malmstrom, Lund (SE); Lars Gustay Malmstrom, Seattle, WA (US); Per Magnus Berglund, Lund (SE); Ulf Christian Ellervik, Lund (SE)

Correspondence Address: Ronald L. Grudziecki, BURNS, DOANE, SWECKER & MATHIS, L.L.P., P.O. Box 1404, Alexandria, VA, 22313-1404, US

(21) Appl. No.: 10/244,600

(22) Filed: Sep. 17, 2002

Related U.S. Application Data
(60) Provisional application No. 60/322,756, filed on Sep. 18, 2001.

(30) Foreign Application Priority Data
Sep. 18, 2001 (SE) 0103103-8

(51) Int. Cl. G01N 27/26; G01N 27/447

(52) U.S. Cl. 204/461; 204/459; 204/466; 204/456; 204/612; 204/610; 204/616; 204/606; 356/243.1; 356/344; 250/252.1; 382/128; 382/129

(57) ABSTRACT

Marker compounds suitable for gel electrophoresis are disclosed. The compounds are natural, non-natural compounds or a mixture thereof, but not a protein. The compounds comprise at least one monomer unit, at least one functional group unit and optionally at least one core unit. Also contemplated is a method for positioning the marker compounds or a set of the compounds according to the invention and a method for the detection and/or quantification of s sample molecule in a two-dimensional gel.

### TECHNICAL FIELD

This invention relates to a marker compound or a set thereof, suitable for gel-electrophoresis, a method for determining of characteristics of said compound or set, a method for detection and quantification of a sample in a gel as well as the use of said compound and set. Also disclosed is a kit of said external marker compound or said set.

### BACKGROUND OF THE INVENTION

Analysing, Detecting and Identifying Proteins Quantitatively and Qualitatively in Cells and Tissue

In a cell, from e.g. a cell culture or tissue sample, an existing pool of proteins, a proteome, exists as a part of biological processes and functions. Knowledge about the identity and amount of a protein or a group of proteins at a certain time point and also of certain changes over time find applications in clinical, diagnostical and analytical situations.

Certain biological processes are defined by changes in morphology and physiology due to changes in the expression, i.e. the protein level, of particular genes. Also, developmental stages of cells can be defined and monitored by their global pattern of gene expression and the progressive changes that occur over time of particular genes or groups of proteins. Even more, as a response to treatment of cells with chemical factors. e.g. drugs, hormones, nutrient factors, environmental factors and other growth condition factors, specific proteins of groups of proteins can change the/their expression and as such allow for monitoring or identifying a response or treatment. Information of this type can be used to e.g. detect, identify and classify tumours in terms of malignancy, evaluation of therapies, adjustment of therapies as well as diagnosis and prognosis. Also, changes in proteins due to mutations, cleavage, phosphorylation or glycosylation can be obtained.

Further identification of unknown proteins can be done by e.g. mass-spectrometry of unidentified sample protein spots on the gel.

Two-Dimensional Gel Electrophoresis

Two-dimensional gel electrophoresis is used as a general method for detecting, identifying, monitoring and quantifying the compositions of complex biological mixtures. Separation performed in two dimensions enables detection and identification of a large number of components that would not be separable and distinguishable in a linear separation.

A frequent way of monitoring the protein expression by 2D gel-electrophoresis is by analysing a set of multiple gels in one run.

Detection and Identification of Sample Spots in a 2D Polyacrylamide Gel

By using large gels, the number of proteins to be detected and identified can be several hundred up to about 10 000 in one gel. Each spot is detected by means of a signal derived from the individual spot.

In a typical gel size of 24×18 cm, several thousands of sample protein spots are detected. Normally, about 10% of the total number of sample spots need to be selected as landmarks. This further involves a few hundred manually selected landmarks in each gel. The process of detection, identification and analysis of the separate components in a two-dimensional electrophoresis gel is a complex and difficult task, and often involves tedious and time consuming steps manual demanding months of experience to perform. Several attempts have been made to develop means and methods to simplify, standardize and automatize the procedure as described in Smilansky et al., 2001, Electrophoresis 22: 1616-1626, Thompson et al., 1998, in 20^{th} Annual International Conference of the IEEE Engineering in Medicine and Biology Society, Vol. 20: 1060-1063, Wanatabe, et al., 1998, in 20^{th} Annual International Conference of the IEEE Engineering in Medicine and Biology Society, Vol. 20:804-808.

The manner in which the sample protein spots are distributed across the two-dimensional gel-electrophoresis depend on the separation parameters used in the first and second dimension in the two-dimensional electrophoresis procedure. Two parameters commonly used are isoelectric point and molecular size (Gorg et al., 2000, Electrophoresis 21:1037-1053).

Various types of signals have been used as post-gel colouring techniques, such as silver staining as described in Sinha et al., 2001, Proteomics 1:853-840, Shevchenko et al., 1996, Anal. Chem. 68:850-858. Also used is e.g.. optical density, radioactive emission, fluorescence emission, and calorimetric signals (Pavon et al., 1999, J Interferone Cytokine Res.19:589-599, Steinberg et al., 2001, Proteomics, 1:841-855, Herich et al., 2001, Biotechniques, 31:146-149, Kemnper at al., 2001, Electrophoresis, 22:970-976, Lauber et al., 2001, Electrophoresis 22:919-932, Berggren et al, 2000, Electrophoresis 21:2509-2521, Steinberg et al., 2000, Electrophoresis 21:486-496). Detection of the spots is commonly achieved by the use of imaging devices that convert these signals into digital data and store the data as information on computer storage media.

Landmarks

One of the key features in identifying the sample spots is the assignment and use of reference spots known as “landmarks”. The landmarks are actual protein spots that are manually selected by the user, i.e. manual landmarking. The software used is further processing the manually selected spots to automatically detect and identify the same spots in all of the member gels in one matchset.

These user-selected landmarks are relatively few in number compared to the total number of sample spots in an individual electropherogram. The selection criteria of the manual landmarks are that the spots should be well-resolved, that they are well isolated from other spots, and that they appear in all the gels of the match-set.

The number of spots to be assigned as landmarks must be large enough so that all of the remaining protein spots among the various gels will be successfully matched by the automatic processing. The function of the landmarks is to serve as guideposts in the gel-to-gel comparison, thereby aiming at reducing and compensating differences and distortions among the member gels in the matchset to assure that there will be a proper correspondence of protein spots among different gels in the matchset.

Further, by using known sample proteins manually chosen as landmarks in the 2-DE one has to consider only proteins that exists in all gels in one matchset. Such protein must exist in a relatively large amount to be readily repeatable and detectable in all of the gels. Due to this, the spots chosen as protein landmarks are often large and blob-like. This gives less defined landmarks that are difficult to position accurately, i.e. to find the exact centre of the landmark, which is a source of inaccuracy on the analysis process of the sample protein spots.

The process of selecting and marking spots to be used as landmarks is slow and tedious and is one of the limiting factors in two-dimensional gel electrophoresis analysis. Normally, since about 10% of the total number of protein spots needs to be selected as protein landmarks to make the image analysis algorithm work correctly, several hours needs to be used for each run to pick said landmarks manually. Also, in addition to assigning the above described selection criteria for manually chosen landmarks, the time involved in making the selections and making the spots adds to the cost and time involved in performing the analysis. Even further, the level of user involvement raises question regarding reproducibility and reliability.

Dendrimers

Dendritic macromolecules, or dendrimers, are synthetic 3-dimensional macromolecules that are prepared in a step-wise fashion from simple branched monomer units, the nature and functionality of which can be easily controlled and varied. Their unique architecture and monodisperse structure has been shown to result in numerous previously unknown or significantly improved physical and chemical characteristics when compared to traditional linear polymers. As a consequence, dendrimers and dendrimer complexes are now considered to be one of the prime nanometer-scale building blocks for construction of nanoscale objects used for e.g. drug delivery and detection of various components of a sample using dendrimers bearing probes and labels as described in WO0102861.

Background

WO0107920 discloses a method for automated landmarking for two-dimensional gel electrophoresis by the addition of marker proteins to the sample proteins. Though, the use of proteins as external landmarks suffers form several disadvantages. The production costs are high and the shelf life of the final protein product is low compared to other organic molecules.

U.S. Pat. No. 5,139,630 discloses a method for detecting and identifying protein species in a sample by capillary zone electrophoresis by the addition of at least two external markers, one being an ionic species and one being a neutral charged species. This method is only applicable for capillary electrophoresis, i.e. where the separation is in one dimension, here disclosed for charge densities, and not applicable for a separation using more than one dimension as in e.g. a two-dimensional gel electrophoresis

WO9707398 discloses dendrimer-polypeptide complex and making thereof. Said complexes are used for binding assays in biological samples, and not for the identification of unknown proteins.

It is thus highly desirable in the light of the aforementioned problems to develop means and methods for reducing time and costs, as well as increasing the reproducibility and reliability of two-dimensional gel electrophoresis used for separation, detection, identification and quantification of proteins, which can also avoid the problems associated with the prior art means and methods. In this respect, the present invention addresses this need and interest.

### SUMMARY OF THE INVENTION

In view of the foregoing disadvantages known in the art when using and analysing two-dimensional gel electrophoresis (2-DE). the present invention provides marker compounds, external landmarks, methods and use thereof, for detection and matching samples in a two-dimensional gel electrophoresis.

An object of the present invention is thus to provide efficient marker compounds, external landmarks, as well as methods and use thereof for a rapid and efficient detection and matching of samples in a two-dimensional gel electrophoresis. Within the object is also considered a way for reducing time and costs, as well as increasing the reproducibility and reliability of two-dimensional gel electrophoresis used for separation, detection, matching and quantification of proteins.

Thus the present invention provides a marker compound suitable for gel electrophoresis, wherein the compound is not a protein. This marker compound may comprise at least one monomer unit, at least one functional group unit and optionally at least one core unit. The marker compound may be characterised by a pI of about 1-12, preferably about 3-10, and/or with a molecular size of 5-10⁶ Da, or 10³-10⁵ Da. The marker molecule may be a dendrimer, comprising at least one monomer, at least one functional group and optionally by at least one core.

The present invention also provides a set of at least two said marker compounds, suitable for gel electrophoresis. Said set form at least two marker spots, i.e. external landmarks, in a gel after electrophoresis, forming a grid on the gel after gel electrophoresis. The grid may be evenly or unevenly distributed on the gel.

Furthermore, the present invention provides a kit of external landmarks comprising at least two of the marker compounds according to the invention or at least one of the sets according to the invention, and optionally at least one buffer or buffer system.

The use of said marker compounds according to the invention or at least one of the sets according to the invention may be for detection and/or quantification of a sample or sample molecule.

Different embodiments may include a use, wherein the detection and/or quantification of a sample or sample molecule is dependent on the pI and molecular size of the marker compound(s).

According to the invention, a method for determining and/or verifying the characteristics of a marker compound according to the invention or a set of external landmarks according to the invention is included comprising the steps of a) preselecting a theoretic positions where a marker compound according to the invention or a set of external landmarks according to the invention is to position, b) designing a marker compound according to the invention or a set of external landmarks according to the invention so as to achieve correct characteristics, c) applying the marker compound or the set in b) above onto the gel, d) separating the marker compound or the set in c) in a first dimension, e) optionally separating the marker compound or set in a second or further dimension, f) collecting information about the separation in d) and optionally in e), g) registrating the information in f) as digital information, and h) determining and/or verifying the characteristics after separation.

The use of said marker molecules and set will give a more reliable and rapid way of performing and analysing gel electrophoresis, such as two-dimensional gel electrophoresis. This is partly due to the quality of said markers, forming even spots on the gel after electrophoretic separation, not dependent on much manual input of the analysis compared to known methods in the art.

### SHORT DESCRIPTION OF DRAWINGS

FIG. 1a shows an example of a two-dimensional gel with protein samples, in black, and with 25 positions for landmarks. The positions are marked with x. The marker spots are positioned evenly over the gel,

FIG. 1b shows the same as in 1a except that the marker spots are positioned unevenly over the gel,

FIG. 1c shows the same as in 1a except that nine marker spots are positioned evenly over the gel,

FIG. 1d shows the same as in 1c except that the marker spots are positioned unevenly over the gel,

FIG. 2 shows a general formula of a dendrimer with a central core, marked with a hexagon, several layers of monomeric units, Y-shaped, and an outer layer of functional groups shown as blacked filled circles. The central core may be mono-, bi-. tri-, or polyfunctional, with one or several layers of monomeric units which can be mono-, bi- or polyfunctional and an outer layer of functional groups,.

FIG. 3 shows examples of structures that may be used as core units in the dendrimer according to the invention,

FIG. 4 shows an example of a dendrimer according to the invention using diaminoethane as the core and 3,5-diaminobenzoic acid as the monomer and aspartic acid as the functional group,

FIG. 5 shows examples of structures that may be used as monomers in the dendrimer according to the invention,

FIG. 6 shows examples of structures that may be used as functional groups in the dendrimer according to the invention,

FIG. 7 shows building blocks to be used in the synthesis of dendrimers in example 1,

FIG. 8 shows the coupling of building block 5a and 5b so as to give a number of dendrimeric structures with different molecular weights according to structures 7a or 7b,

FIG. 9 shows the synthesis of the marker compound 10c from the dendrimer DAB-Am-16 (Polypropylenimine hexadecaamine dendrimer, Generation 3.0) shown as 8a. Boc-Asp(OBzl)—OH is shown as 2b,

FIG. 10 shows the synthesis of the marker compound 11c from the dendrimer DAB-Arm-64 (Polypropyleniminc tetrahexacontaamine dendrimer, Generation 5.0) shown as 8b. Boc-Asp(OBzl)—OH is shown as 2b,

FIG. 11 shows the synthesis of compound 10a by coupling DAB-Am-16 shown as 8a. Phthalic anhydride is shown as 9a,

FIG. 12 shows the synthesis of compound 10b by coupling DAB-Am-16 shown as 8a. Succinic anhydride is shown as 9b,

FIG. 13 shows the synthesis of compound 11b by coupling DAB-Am-64 shown as 8a. Succinic anhydride is shown as 9b, and

FIG. 14 shows the synthesis of compound 11a by coupling DAB-Am-64 shown as 8a. Phthalic anhydride is shown as 9a.

### DETAILED DESCRIPTION OF THE INVENTION

Definitions

As used herein, the term “spot/s” intends to mean a cluster of compounds migrating identically in a gel electrophoresis thereby ending up at the same relative position on the gel. The spot may be formed by sample molecules or compounds, the spots then herein referred to as “sample spots”; or from marker compounds, such spots then herein referred to as “landmarks”, “external landmarks”, “landmark spots” or “marker spots”.

The term “external” is herein intended to mean not originating, selected or chosen from the original sample or sample molecules. Thus, “external landmarks” or “external marker compounds” is therefore not originating, selected or chosen from the original sample or sample molecules.

The term “sample” or “sample molecule(s)” is herein intended to mean a known or unknown biological sample comprising proteins to be separated in a gel electrophoresis for further analysis. “Further analysis” is herein intended to mean identification and/or quantification.

The term “identification” is herein intended to mean to find identity with a previous migration pattern in a gel electophoresis due to physical, chemical or physiochemical characteristics of the sample, or identity with a known compound.

The term “matching” is herein intended to mean a process of detecting and matching corresponding spots in different gels. Following this, the term “sample matching” is herein intended to mean a process of detecting and matching the same sample in different gels.

The term “matchset” is herein intended to mean a group of gels that are to be compared to each other for purpose of observing changes in individual sample spots.

The term “natural” is herein intended to mean anything existing in nature, not being derived from a synthetic process, except for a purification and/or an enrichment step.

The term “non-natural” is herein intended to contrast the term “natural”, i.e. a synthetic or artificial compound being man-made, not existing in a natural form.

The term “protein” is herein intended to consist essentially of linear combinations of amino acids in peptide linkage, forming polypeptides. A protein may be built from more than one polypeptide chain.

The term “monomer” is herein intended to mean one building block or building molecule. Several monomers may be collected in a “monomer unit” distributed over several layers.

The term “functional group” is herein intended to mean a molecule or a part of a molecule or building block, that gives a certain characteristic to said molecule.

The term “core” is herein intended to mean a centre, focus the central or innermost part of the molecule or building block.

External Landmarks

As revealed above, the present invention relates to gel-electrophoresis and to marker compounds to be used, which are more reliable and more rapid than by using current means and methods known in the art. Such marker compounds form spots, or external landmarks, after gel electrophoresis to be used for identification and/or quantification of a sample or sample molecule(s).

Present ways of detecting and matching proteins on a gel after gel electrophoresis include the denotation of sample molecules, e.g. the sample proteins, in the gel seen as spots, to marker proteins or marker spots. This will introduce technical problems such as less accuracy between different gels and matchsets and is tedious for the analyst as well as difficult to repeat.

Accordingly, as revealed above, marker compounds with known characteristics are therefore added externally according to the invention, thus forming external landmarks on the gel after electrophoresis. As external marker compounds, they may be added to, but are not selected and chosen from the sample molecules, e.g. proteins. The externally added marker compounds may in different embodiments be added separately to the preparation of sample molecules, e.g. proteins, or included separately to the gel before or during the run.

By selecting marker compounds with known and pre-chosen characteristic, such as, e.g. pI and molecular size values, the external added marker compounds may position in a desired way over the gel. Such information about characteristics of the external marker compounds may be used for further analysis of unknown samples, such as unknown proteins.

The Marker Compound

According to the invention, a marker compound suitable for gel electrophoresis, wherein the compound is a natural, non-natural compound or a mixture thereof and wherein the compound is not a protein is used. The marker compounds are added externally, and not chosen from the samples, as revealed above.

The marker compound may be a polymer or it may be selected from the group consisting of glycoconjugates, carbopeptoides, polynucleotides, proteoglycanes, fullerenes, carbohydrates and mixtures thereof.

The size and pI of the marker compound should be in the range of the sample molecules to be detected and identified.

In specific embodiments, the marker compound is characterised by a pI of about 2-12. In still further embodiments, it is characterised by a pI of about 3-10.

Further embodiments include marker compound characterised by a Mw of about 5-10⁶ Da. In still even further embodiments, the Mw may be of about 10³-10⁵ Da, 5-1000 Da, 5-600 Da, 5-250 Da or an otherwise suitable interval of molecular size due to the size of the samples to be separated and detected.

Specific embodiments comprise marker compounds characterised by a pI of about 1-12 and by a Mw of about 100-10⁶.

The marker compound may also be a dendrimer, further described in the paragraph below.

Dendrimers as Marker Compounds

The external marker compound according to the invention may in specific embodiments of the invention be a dendrimer. Dendrimers are built up from different structural building blocks that may include branching points to achieve a tree like structure characteristic for dendrimers. The different building blocks are coupled together to achieve said treelike structure.

The dendrimers offer two important features when used as marker compound, namely a) the size can be easily modified by adding more layers and b) the feature of the dendrimeric compounds can be modified by adding different functional groups to the layers. Since the individual building blocks may be composed of repeatable units, the dendrimer molecule may be built up from only a few numbers of coupling steps, which is economically and technically advantageous.

According to the invention, the dendrimer may comprise at least one monomer, at least one functional group and optionally at least one core as building blocks.

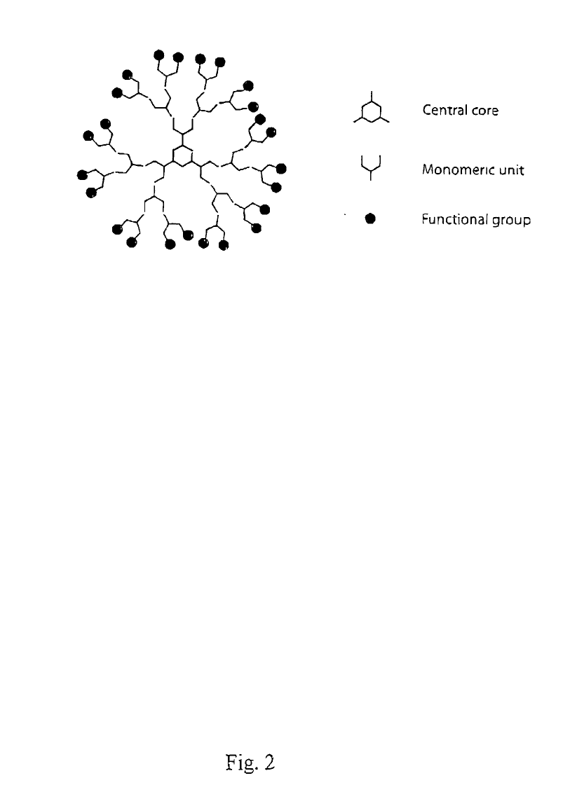

The dendrimer may be built up from separate building blocks as shown in FIG. 2. Said dendrimers may be built up either by a divergent strategy or by a convergent strategy as known in the art of dendrimer synthesis.

In one embodiment of the invention, the dendrimer to be used as external marker compound according to the invention is synthesised according to the divergent strategy.

The dendrimer may be represented by the general formula

(core)ₙ(monomer_{1 . . . o})ₓ(functional group_{1 . . . p})

wherein n is an integer from 0-5 representing number of different co-existing optional cores,

wherein o is an integer from 2-1000 representing number of different monomer building blocks within the monomer distributed over x layers,

wherein x is an integer from 1-20 representing number of layers, and

wherein p is an integer from 1-20 representing the number of different functional groups within one functional group building block.

Other suitable dendrimers to be used as marker compounds according to the invention are commercially available dendrimers. Though, such dendrimers lack at least one functional group according to the invention. Such a functional group may then, of course, be coupled onto the commercially available dendrimers using techniques known to the skilled man in the art. Examples of, but not limited to, commercially available dendrimers that may be used according to the invention are Astramol™ (DSM Agro, The Netherlands) and Starbust® (Aldrich)

In specific embodiments of the invention, synthetic amino acid dendrimers will be used. In still further specific embodiments, a diamin or a triamin is used as a core, diaminobenzoic acid as a monomer and aspartic acid as a functional group. By introducing different numbers of diaminobenzoic acid as a monomer a huge range of molecular masses may be achieved as exemplified in table 2.

TABLE 2
Molecular size of dendrimers
made of a diamin as core building block,
diaminobenzoic acid as a monomer (mon)
and aspartic acid as a functional group.

| mon | Molecular size |
|---|---|
| 0 | 290 |
| 1 | 788 |
| 2 | 1785 |
| 3 | 3779 |
| 4 | 7767 |
| 5 | 15743 |
| 6 | 31694 |
| 7 | 63597 |

The Dendrimer Core

According to the invention the external marker compound may comprise a dendrimer, as exemplified above. The dendrimer may comprise at least one core.

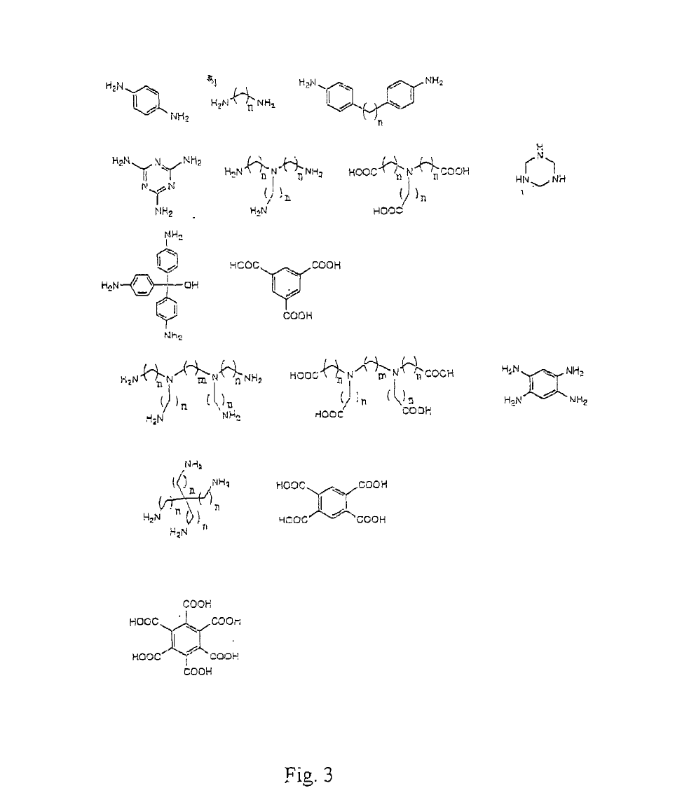

According to specific embodiments, the core may be divalent, trivalent, tetravalent, or a multivalent core and mixtures thereof According to the invention, the at least one core may be selected from the group consisting of the formulas in FIG. 3 and mixtures thereof.

In a preferred embodiment, the core may be a diamine where n=2 or a triamine where n=1.

The core may contain further branching units, allowing the treelike structure characteristic of the dendrimer to form.

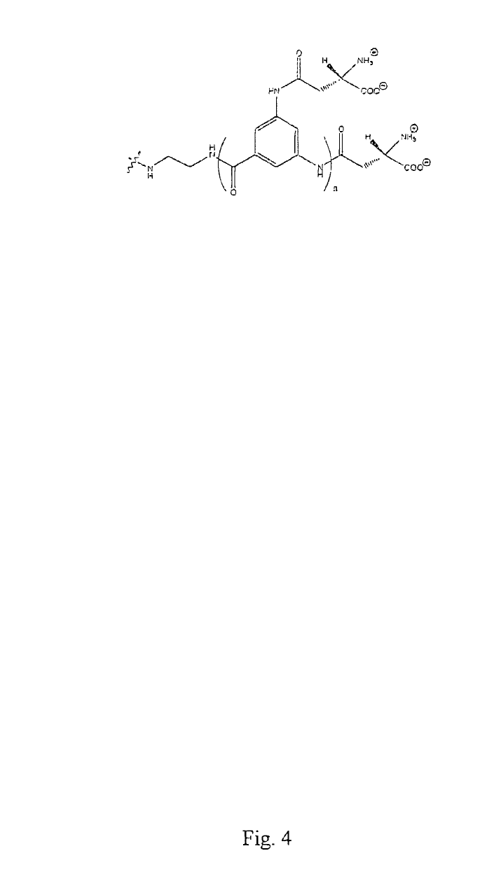

An example of a dendrimer using diaminoethane as the core is shown in FIG. 4.

The Monomer

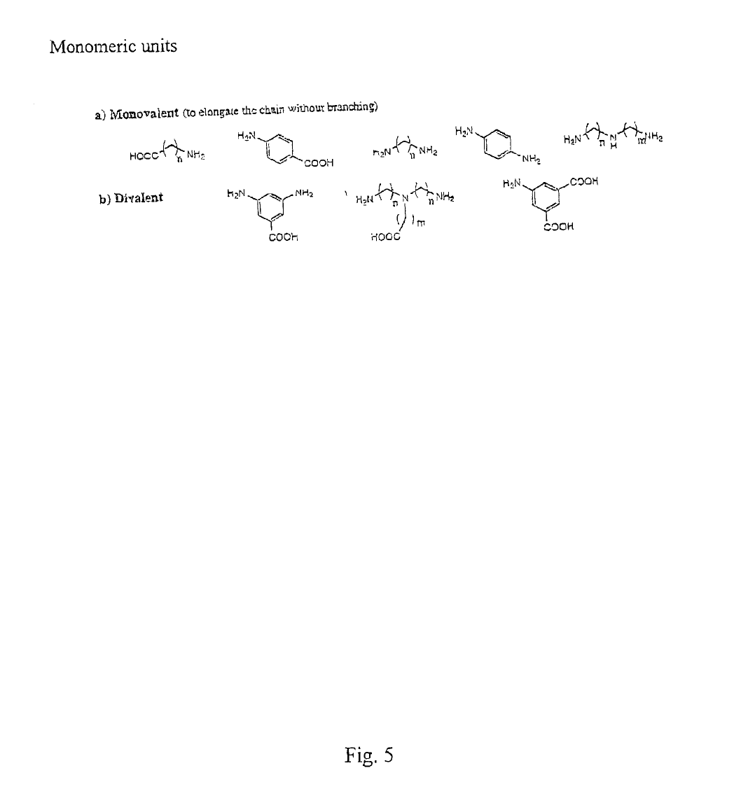

The dendrimer also comprises at least one monomer The monomer may include further branching possibilities to the dendrimer molecule to achieve the treelike structure characteristic of the dendrimer. Due to the numbers of branching possibilities, the monomer may be monovalent, i.e., to elongate without branching, divalent, trivalent, tetravalent, multivalent or mixtures thereof. Examples of such monomers with monovalent and divalent branching units are shown in FIG. 5.

Specific embodiments use amid bondings between the different monomers.

In still a further embodiment, the at least one monomer may be 3,5-diaminobenzoic acid, as shown in FIG. 4.

The number of monomers will contribute to the final molecular size of the dendrimer. According to specific embodiments, using 3,5-diaminobenzoic acid as monomer the monomer may be in a number of 1-10.

The Functional Group

The dendrimer may also contain a functional group according to the invention. The at least one functional group will to the dendrimer ad known characteristics. An example of known characteristics is, e.g. a desired net charge of the molecule.

In specific embodiments, at least one functional group may be added to the free ends generated in the coupling step. Due to the addition of the at least one functional group, the landmark will according to the invention be able to position in the gel if the gel parameters used for separation are selected so as to enable separation of the marker compound characteristics.

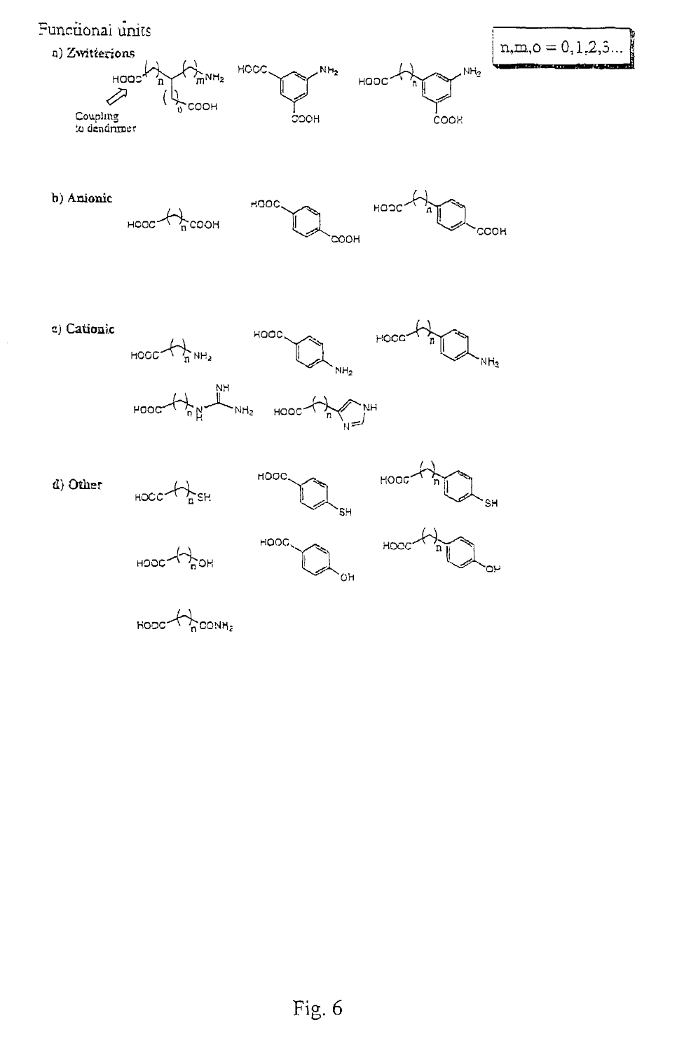

According to different embodiments the at least one functional group may be selected from the group of functional groups shown in FIG. 6, and zwitterions, anionic or cationic, oligopeptides, alcohols, tiols, carboxy acids, amines; fluorochromes, such as fluorescamine, isotopes and mixtures thereof.

In a specific embodiment, the fluorescamine used is the commercially available Fluram® available from Molecular Probes, U.K.

In still further specific embodiments, the at least one functional croup is selected from the group consisting of an amino acid such as aspartic acid, glutamic acid.

According to the invention, the marker compound has known characteristics affecting its migration in a gel during gel electrophoresis so as to position the marker compound in said gel. Such characteristics may, of course, be included by the addition of a functional group to the dendrimer. Even further, it may reflect the molecular size of the marker compound.

In specific embodiments, the known characteristics may affect the migration in at least two dimensions in said gel.

In still further embodiments, such known characteristics may be dependent on pI and molecular size.

The Set of External Landmarks

According to the invention, above said marker compounds can form a set of external markers suitable for gel electrophoresis, comprising at least two different marker compounds described above.

According to the invention, said set may form at least two marker spots, i.e. external landmarks, in a gel. As such, said two spots will appear in different areas in the gel, due to the known characteristics of the marker compounds that form said spots due to a separation in at least one dimension.

The number of marker spots in a gel may differ. This is due to the large number of different types of gels to be used in the gel electrophoresis step. Another factor that may affect the number of markers needed are the number of sample spots on the get, which is obvious for the skilled man in the art of gel electrophoresis and separation of samples such as e.g., protein samples. Other factors that affects the number of marker spots needed are the number of separation dimensions which are, according to the invention, at least one, preferably two, but may also be more than two, e.g. three. The number of marker spots needed may therefore be, e.g. about 0-50% of the number of sample spots, preferably 1-20%, even more preferably 1-10% of the number of sample spots.

Specific embodiments of the invention may use marker spots, wherein the at least two marker spots may be from about 2-1000 marker spots per said gel.

In still further embodiments, the at least two marker spots may be from about 2-500, such as about 2, 3, 4, 5, 6, 7, 8, 9, 10, 11, 12, 13, 14, 15, 16, 17, 18, 19, 20, 21, 22, 23, 24, 25; or about 30, 35, 40, 45, 50, 55, 60, 65, 70, 75, 80, 85, 90, 95, 100; or about 100, 200, 300, 400, 500 marker spots per gel.

Even further embodiments include about 500-1000 marker spots per gel, such as about 500, 600, 700, 800, 900 or 1000 marker spots per gel.

In a specific embodiment, the number of marker spots needed is such as about 5-40 marker spots. This may apply for a gel, such as a two dimensional gel e.g. a polyacrylamid gel, in a size of about 24×18 cm.

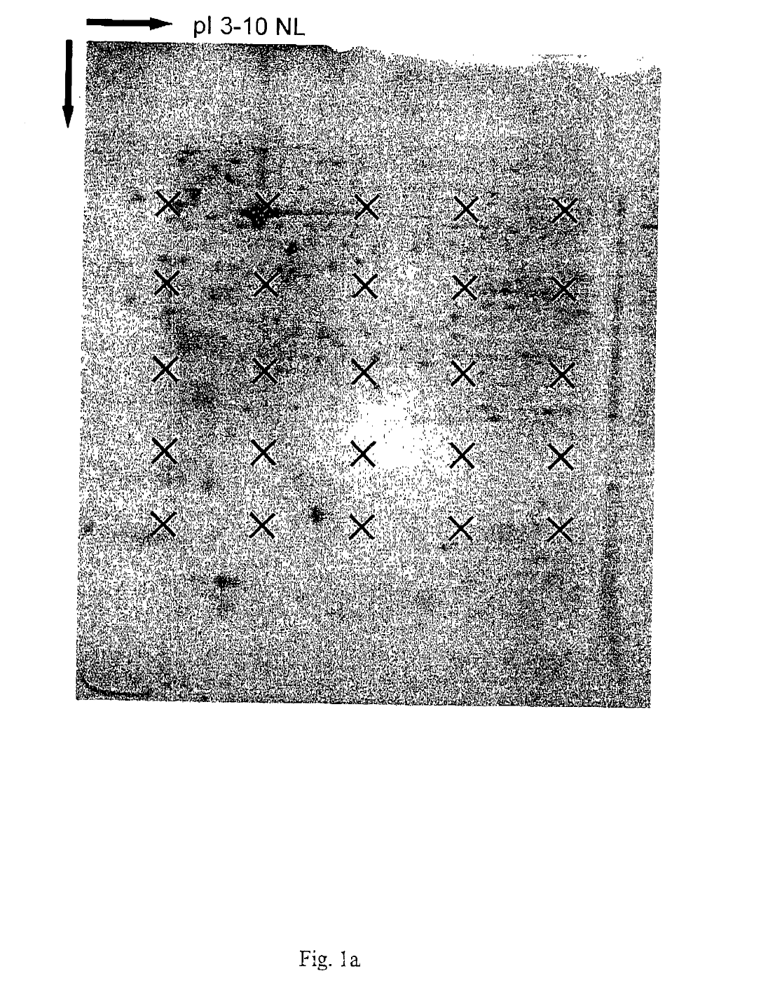

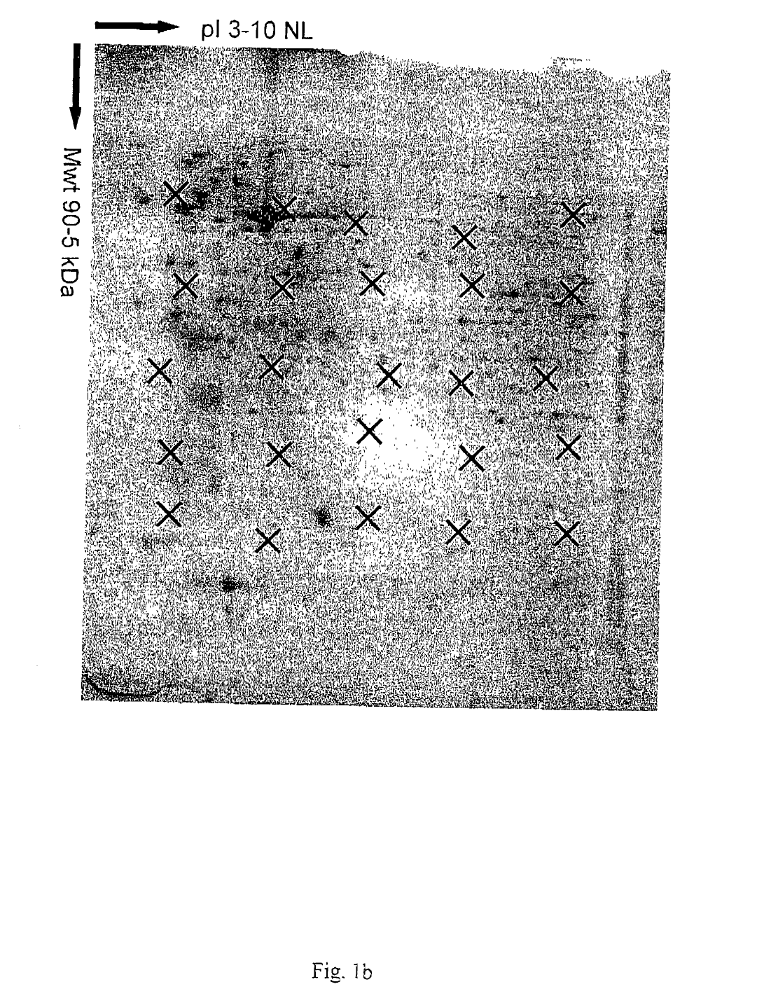

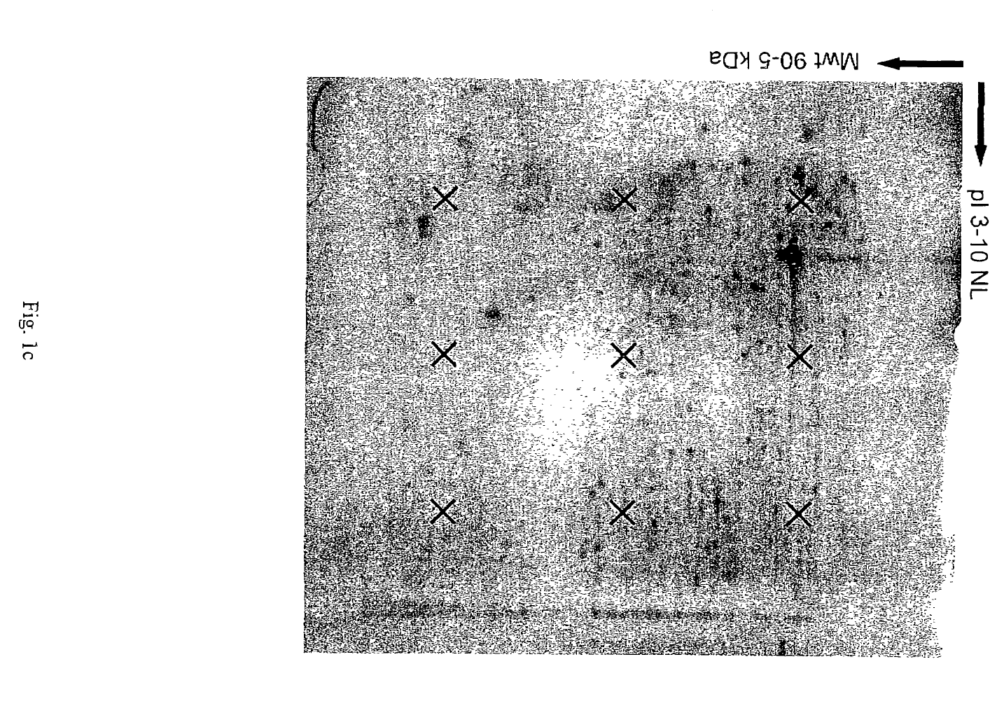

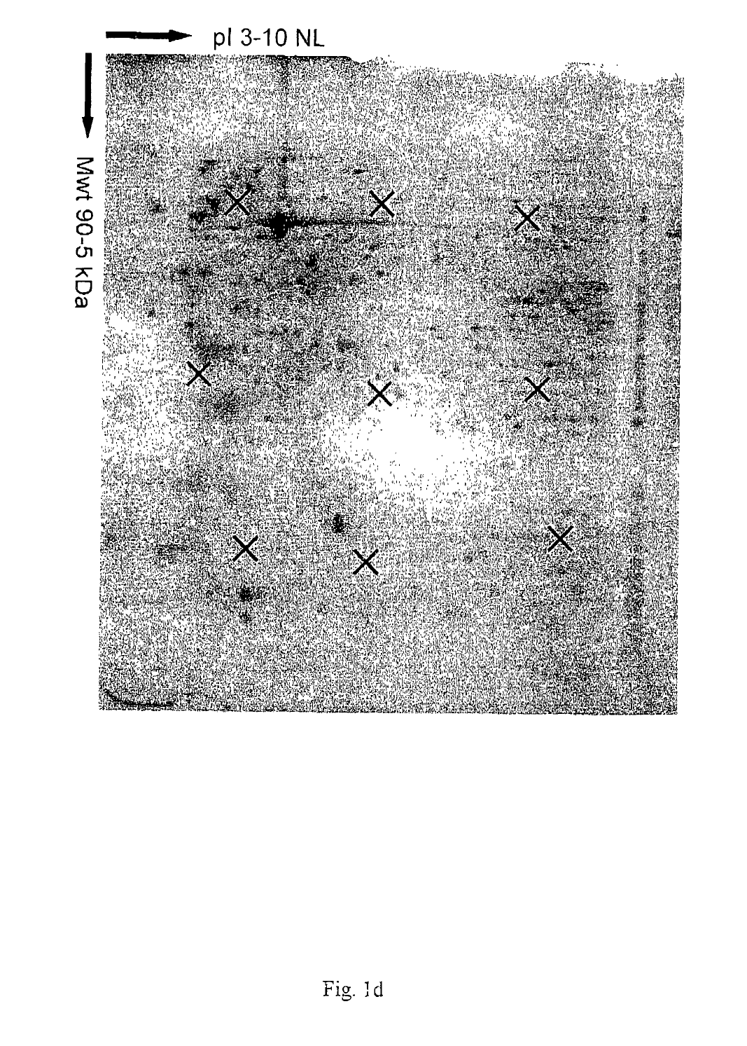

Specific embodiments are wherein the at least two marker spots form a grid in said gel. Still further embodiments are wherein said grid may be evenly or unevenly distributed in the gel, i.e., in different densities over the gel, according to chosen preferences. This is to overcome and compensate for differences and/or distortions in a gel or group of gels to be analysed and compared. This will improve and render the spot matching of the landmarks and the protein samples more effective. Examples of such grids are shown in FIGS. 1a-d, FIG. 1a shows an example of a two-dimensional gel with protein samples, in black, and with positions for marker spots, i.e. external landmarks. The positions for said marker spots are marked with an “X” in the gel In FIG. I a, the spots are distributed evenly over the gel. In FIG. 1b, the same is shown, but the marker spots are distributed unevenly over the gel. FIG. 1c and 1d shows the same as in 1a and 1b, but with nine marker spots.

Said marker spots contain different number of marker compounds per marker spot. The amount of marker compounds should be, though, as is evident to the skilled man in the art, enough to allow a clear and concise detection of the marker spot on the gel. This is, of course, dependent on how the sample spots are detected, equipment and/or gel resolution.

According to specific embodiments of the invention, the at least two marker compounds forming at least one marker spot may position in at least one dimension in a gel, such as a polyacrylamide gel, at pre-chosen positions. As used herein, the word pre-chosen is intended to mean pre-chosen due to empirical information, such as experimental data, or from theoretical information, such as chemical and/or physical data characterising the at least one marker compound used. The at least two marker compounds may be designed to be dependent upon e.g. pI and molecular size for their positioning. Of course the marker compounds may be designed in different ways, as obvious to the skilled man in the art, to depend upon other characteristics for separation according to other dimensions than pI and molecular size.

The set of external landmarks may in specific embodiments comprise at least two marker compounds forming at least two spots, wherein the at least two marker compounds are characterized by a pI of about 1-12, such as about 3-10.

In still further embodiments, the at least two marker compounds may be characterised by a Mw of about 100-10, such as about 10³-10⁵.

Specific embodiments may be where the at least two marker compounds may be characterised by a pI of about 1-12 and a Mw of about 100-10⁶.

In still further embodiments of the invention, the set of external landmarks form a grid on said gel due to the fact that the characteristics of the marker forming the spots are pre-chosen compounds.

Characteristics of a Dendrimer According to the Invention

Examples of dimensions used for separation of sample proteins and external marker compounds are separations based on e.g. the molecular size and pI of the marker molecule and/or sample protein.

As described above, the separation of marker compound and/or the sample/s are performed in at least one dimension. This means that the separation, accordingly, is dependent on such characteristics of said compound and/or sample.

In the specific embodiments of the invention separation is dependent on the pI of the external landmark. To achieve this for the marker compound, e.g. a dendrimer, a functional group is added as described above, till the landmark will theoretically and/or empirically position at the desired pre-chosen spot in the gel.

The second dimension may be a separation due to the molecular size of the landmark. This is done simply by adding at least one building block of the monomer, which may be branched. Different sizes of the dendrimer marker compound are then simply achieved by adding a different numbers of said monomer to the optional core structure.

According to specific embodiments, the free ends may protrude from the dendrimer structure or reside in the more interior part of the branching treelike structure. Further examples of cores, monomers, and functional groups to be used in different embodiments are shown in FIG. 3-6.

A Kit of External Landmarks

The present invention also includes a kit of external marker compounds, comprising at least two, of the marker compounds according to the invention, or at least one of the sets of external markers according to the invention, and optionally at least one buffer or buffer system.

The kit may, in different embodiments, comprise at least two marker compounds according to the invention, or the set according to the invention wherein said set or compound is to be dissolved upon usage or is pre-dissolved in a solution.

Thus, the at least two marker compounds according to the invention, or the set according to the invention may specific embodiments in the kit be supplied in a dry format, such as a powder form format, in a pellet format, a granula format, or a flakes format.

In further embodiments, the at least two marker compounds according to the invention, or the set according to the invention may in the kit be supplied in a pre-dissolved format such as in a solution, e.g. in a suitable buffer, an aqueous solution, or in an organic solvent.

Still further embodiments may comprise a kit wherein at least one applicator strip suitable for gel electrophoresis is included. Examples of, but not limited to, suitable applicator strips comprises agarose and/or polyacrylamide strips, such as Immobiline Dry Strips obtainable from Amersham Pharmacia Biotech, e.g. the 3-4% polyacrylamide gel 3-10 NL pI strips. Other suitable strips that may be included are given in table 3. The examples in table 3 are only to be considered as examples and not in any way limit the scope of the invention.

TABLE 3
Suitable applicator strips that may be included
in the kit.

| Company | Type of strip |
|---|---|
| Amersham Pharmacia | Immobiline Dry Strip ™, |
| Biotech | |
| Biorad | Ready Strip IPG-strip ™, |
| | Tube Gel IEF 2-D |
| | system ™ |

Even further embodiments may contain a pre-casted gel suitable for gel electrophoresis. The choice of gel to use is obvious for the skilled man in the art and may differ depending on the particular application. It may be a gel suitable for two dimensional gel electrophoresis, such as an agarose gel, a polyacrylamid gel or a mixture thereof in a suitable concentration or an otherwise known in the art suitable gel composition in a suitable concentration.

Still further embodiments may comprise enough of said external marker compound or set according to the invention to be used in one or multiple gel runs.

Even still further embodiments may include a manual describing the method, a certificate for the kit, constituents and Guidelines for the usage of the kit as well as analysis procedure. Said manual may also be supplied on a compact disc, CD, on a server reachable for the user or a regular disc floppy and may also be interactive for the user.

Use of External Landmarks

The use of external landmarks, or marker compounds, according to the invention, or a set thereof according to the invention, comprises using marker compounds in gel electrophoresis where the marker compounds may, due to its chemical, physical or physiochemical characteristics, migrate, and optionally separate if more than one type of marker is used, in said gel together with sample molecules. Marker compounds positioning at the same position in the gel will form spots, i.e. marker spots that are readily detectable for further analysis. The migration and separation of said marker compounds is done in at least one dimension, such as in two dimensions where the two dimensions may be dependent on the pI and molecular size of the marker molecule.

According to the invention, the use of said marker compounds according to the invention or at least one of the sets according to the invention may be for detection and/or quantification of a sample or sample molecule.

Different embodiments may include a use, wherein the detection and/or quantification of a sample Or sample molecule is dependent on the pI and molecular size of the marker compound(s).

A Method For Determining and/or Verifying Characteristics of Marker Compounds

The invention provides a marker compound with specific and pre-chosen chemical, physical or physiochemical characteristics. The characteristics may be a specific and pre-chosen pI or molecular size, thereby affecting the migration characteristics of the marker compound during a gel electrophoresis. To determine and/or verify the characteristics of such compounds, a method is provided.

According to the invention, a method for determining and/or verifying the characteristics of a marker compound according to the invention or a set of external landmarks according to the invention is included comprising the steps of

a) pre-selecting a theoretic positions where a marker compound according to the invention or a set of external landmarks according to the invention is to position,

b) designing a marker compound according to the invention or a set of external landmarks according to the invention so as to achieve correct characteristics.

c) applying the marker compound or the set in b) above onto the gel,

d) separating the marker compound or the set in c) in a first dimension,

e) optionally separating the marker compound or set in a second or further dimension,

f) collecting information about the separation in d) and optionally in e),

g) registrating the information in f) as digital information, and

h) determining and/or verifying the characteristics after separation.

In further embodiments, the first dimension may be pI or molecular size.

In further embodiments, the first dimension is pI and the second dimension is molecular size.

In further embodiments, the first dimension is molecular size and the second dimension is pI.

In different embodiments the method in a-h above includes different ways of applying said marker compound or set. E.g., the application of the marker compound or set in step c) above may include applying the marker compound or set in the form of application strips or mixing and applying the marker compound or set together with the test samples or applying the set at the time of casting of the gel.

Examples of, but not limited to, suitable application strips are Immobiline Dry Strips® made of 3-4% polyacrylamid gel, such as the 3-10 NL pI strips obtainable from Amersham Pharmacia Biotech.

The separation in step e) above may be in further dimensions. Different embodiments may be wherein the further dimensions are 3, 4 or even more dimensions. A specific embodiment is wherein the separation in step e) above is a separation in a second dimension.

The separation of the set may be dependent upon different characteristics of the marker compounds. As such, different embodiments of the method includes a method as described above, wherein the separation is in at Least two dimensions and wherein the two dimensions are dependent on pI and molecular size of the marker compound.

Information about the position of each separated marker compound needs to be collected and stored. Accordingly, embodiments of the invention are wherein the collecting information about the position in step f) above, is done by using any of the determination processes selected from the group consisting of visual light, UV, IR, multispectral imaging isotope labelling, colouring techniques, e.g. silver staining, Comassie staining; fluorescence e.g. DIDGE (R) Staining™ (Amersham), fluorochromes such as fluorescamine, and mixtures thereof.

A Method For Detecting and/or Quantification of Sample Molecules and External Landmarks

A method according to the invention for detection and/or quantification of a sample and/or external landmark in a gel comprises the steps of

a) adding the sample to the gel

b) adding the at least two marker compounds according to the invention or the at least one set according to the invention with known identity and known characteristics on the gel,

c) separating said sample and/or marker compound in b) above to form, with said at least two marker compounds or set of external landmarks added, an array of spots of the sample proteins and at least two of the marker molecules or at least one of the sets, respectively,

d) collecting information about the positions of the array of spots in at least one image and optionally superimposing the images,

e) registrating the information in d) above as digital data, and

f) analysing and/or correcting and optionally changing the image or images to detect, quantify and optionally verify the sample. The verification may include, if possible, an identification of said sample molecule.

The method may in specific embodiments be a method wherein the adding in step a) and/or b) above includes adding the sample and/or the at least two of the marker molecules or the at least one set in application strips, or mixing and applying the at least one set or the at least two marker molecules together with the test samples or applying the at least one set or the at least two marker molecules at the time of casting the gel.

Still further, the method may in the separation in step c) above be performed in at least two dimensions and the array formed in step c) above may then be an array in at least two dimensions. In even further embodiments, the said separation in two dimensions may be two-dimensional gel-electrophoresis, wherein the gel-electrophoresis may be polyacrylamide gel-electrophoresis, and wherein the two dimension may be dependent on pI and molecular size.

The samples further needs to be correlated to the marker molecules so as to achieve information about the samples The method according to the invention may in different embodiments include correlating the sample to the at least two marker molecules or the at least one set with known positions and characteristics, and optionally correcting for background noise and distortions, and assigning the sample at least one characteristic in the analysing in step f) above.

Further, the known characteristics of said at least two marker compounds or the at least one set may be dependent on their molecular sizes, and step f) above may further comprise assigning a molecular size to at least one sample based on the molecular size of said set of external landmarks.

Even more further, the known characteristics of said at least two marker molecules or the at least one set are dependent on their pI, and step f) in the method above further comprises assigning a pI to at least one sample based on the pI of said set of external landmarks.

Also, embodiments include a method wherein the known characteristics of said set of external landmarks may be dependent on their molecular sizes and their pI, and step f) in the method above may further comprise assigning a molecular size and a pI to at least one sample based on the molecular size and the pI of said set of external landmarks.

Detection of Artificial External Landmarks

By using external landmarks according to the invention, one may detect the landmarks in an alternative way compared to the sample molecules. Examples of different ways of detecting the external landmarks according to the invention is by using any of the determination processes selected from the group consisting of visual light, UV, IR multispectral imaging, isotope labelling, colouring techniques, e.g. silver staining, Comassie staining; fluorescence. e.g. DIDGE (R) Staining™ (Amersham) fluorochromes such as fluorescamine and mixtures thereof.

The detection of landmark spots may be done by using:

1. The shapes of the landmark spots, both in two and three dimensions.

2. The pattern/s of the landmark spots in the gel.

3. A combination of both shapes and pattern/s of the landmark spots in the gel.

4. Positions of the landmark spots in the gel.

5. A combination of both shapes and positions of the landmark spots in the gel.

6. A combination of both positions and pattern/s of the landmark spots in the gel. A combination of shapes, patterns and positions of the landmark spots in the gel.

Said alternative ways of detecting the external landmark will give a more accurate positioning due to less interference with the protein sample spots.

In specific embodiments of the invention the amount of external landmarks may be chosen in such a way that the landmark spots positioned are evenly formed for all the spots. The spots may also be chosen in preferred embodiments to allow for quantitative analysis of the protein sample spots since known and exact amounts of the external landmarks may be chosen. Evenly formed landmarks will give a higher accuracy and reproducibility in the analysis process due to a simplified process when choosing the centre of the landmark spot compared to when using proteins that may form large irregular blobs in the gel. Such regularly shaped external landmarks according to the invention, that may be detected in a different way than the sample proteins, may be added in a small amount due to high reproducibility and reliability.

The external landmarks according to the invention will reduce the input of manual work due to the readily and accurate detection of said landmarks. The detection of the landmarks may be done fully automatically by in the art known techniques for spot detection. An image produced by e.g. scanning of the landmarks may further be superimposed onto the image of the sample proteins before further processing and analysis of the electrophoresed sample proteins.

Separating the External Landmarks According to the Invention

A way of separating the external landmarks according to the invention may be done as described below in this paragraph. In this specific embodiment, external dendrimer marker compounds are separated in two dimensions in a polyacrylamide gel. The experimental procedure is performed over 4 days. One or more dimension may be used in other embodiments and the separation may be performed over one or several days.

A rehydration of the samples, i.e. both the external marker compound and the sample molecules, is done on day 1. The samples may be dissolved in 125-500 μl solubilisation solution such as of 2M thiourea, 7M urea, 4% CHAPS, 0,3% DTT and 0,5% IPG buffert. The samples may then be pulled into the strip by diffusion overnight in a tray.

On day 2, the separation in the first dimension may take place. The strips may be aligned in a first dimension separation system such as a Multiphore (supplied by e.g. Amersham Pharmacia Biotech). Different embodiments may, of course use similar equipment as is known by the skilled man in the art of isoelectric focusing such as an IPphore (supplied by e.g. Anersham Pharmacia Biotech) or similar. The proteins may further be focused for 5-40h at 3500-8000 V.

On day 3, the 2^{nd} dimension separation may be performed. The strips formed day 2 may be equilibrated in equilibration solution such as 30% glycerol, 2% SDS, 6M urea and 50 mM Tris/HCL, supplemented with 65 mM DTT, and secondly 259 mM iodocetamine to reduce and alkylate the sample. According to knowledge within the art, samples may be reduced, alkylated and separated optimally for the specific samples and markers added to the separation. The strips may be applicated onto the polyacrylamide gel and run in the 2^{nd} dimension in a running buffer comprising 0,1% SDS, 24 mM Tris-base and 0,2 M glycin, or similarly. The separation is performed for a certain number of hours to achieve a proper separation e.g., for about 20 h at 100V or similarly as found suitable by the skilled man in the art.

On day 4, staining and scanning of the samples and the external markers may be performed. Different methods may be used here, as described in the paragraphs above. One way of staining and detecting the samples and the markers is silver staining, as is a well-known procedure in the art. For silver staining, the gel is fixed in e.g., 50% ethanol, 5% HAc, 45% water, milliQ quality, for about 1h. Further on, the gel is washed in e.g., 50% ethanol and subsequently in water for about 30 minutes each. A silver staining may be done according to methods known in the art, or in a modified way, as is obvious for the skilled man in the art. One example of a modified silver staining to be performed for developing the gel may be wherein the gel is sensitized in 0.02% sodium thiosulfate and stained with 0,1% silver nitrate. Further, the gel may be developed in 0.04% formaldehyde, 2% sodiumcarbonate till the samples are visualised enough for detection. The staining process may be stopped by adding approximately 500 ml 5% acetic acid, or in another way, as is obvious to the skilled man in the art.

The stained gels, both containing separated landmarks and sample molecules, may be scanned in a scanner with dual detection possibility. With dual detection possibility, it is intended to mean that the scanner has the possibility to detect signals from different staining techniques, such as silver staining, fluorescent staining, radioactivity, or any other staining method used.

The landmarks are detected in a separate image after a scanning step, enabling detection of the landmarks only. Without changing the position of the gel, the parameters of the scanning apparatus are changed, so as to enable a separate scanning and detection of the separated sample molecules, i.e. the proteins.

The two gel images, one with the separated landmarks and one with the separated sample proteins, now collected in digitalized form, are subsequently used for the image analysis of the gel.

The gel may also be scanned once, detecting the sample molecules and the proteins in one image. This may be convenient when the same detection methodology is used for the sample molecules and the landmarks.

### EXAMPLES

### Example 1

This example describes without limiting the invention the synthesis of dendrimers for use as marker compounds and external landmarks in 2D-gel electrophoresis.

Objective

The objective of this example is to synthesize dendrimers of different molecular sizes and pI. The sizes chosen are approximately 4000 and 16000 and the pI approximately 3-4 and 6-8.

Material

N-β-t-Boc-β-alanine (Boc-β-Ala-OH), N-α-t-Boc-L-aspartic acid β-benzyl ester (Boc-Asp(OBzl)-OH), N,N′-dicyclohexylcarbodiimide (DCC), and N-Hydroxybenzotriazole (HOBt) were purchased from Novabiochem.

N,N-Dimetylformamide (DMF), dichloromethane (DCM), heptane, diisopropyl ethylamine (DIPEA), metanol (MeOH), trifluoroacetic aid (TFA), anisole, sodium hydroxide (NaOH). acetonitrile (MeCN), 3,5-diamino-benzoic acid, 1,2-diaminoethane, and Citric acid were purchased from Merck.

Polypropylenimine hexadecaamine dendrimer, Generation 3.0 (DAB-Am-16) and Polypropylenimine tetrahexacontaamine dendrimer, Generation 5.0 (DAB-Am-64) were purchased from Aldrich.

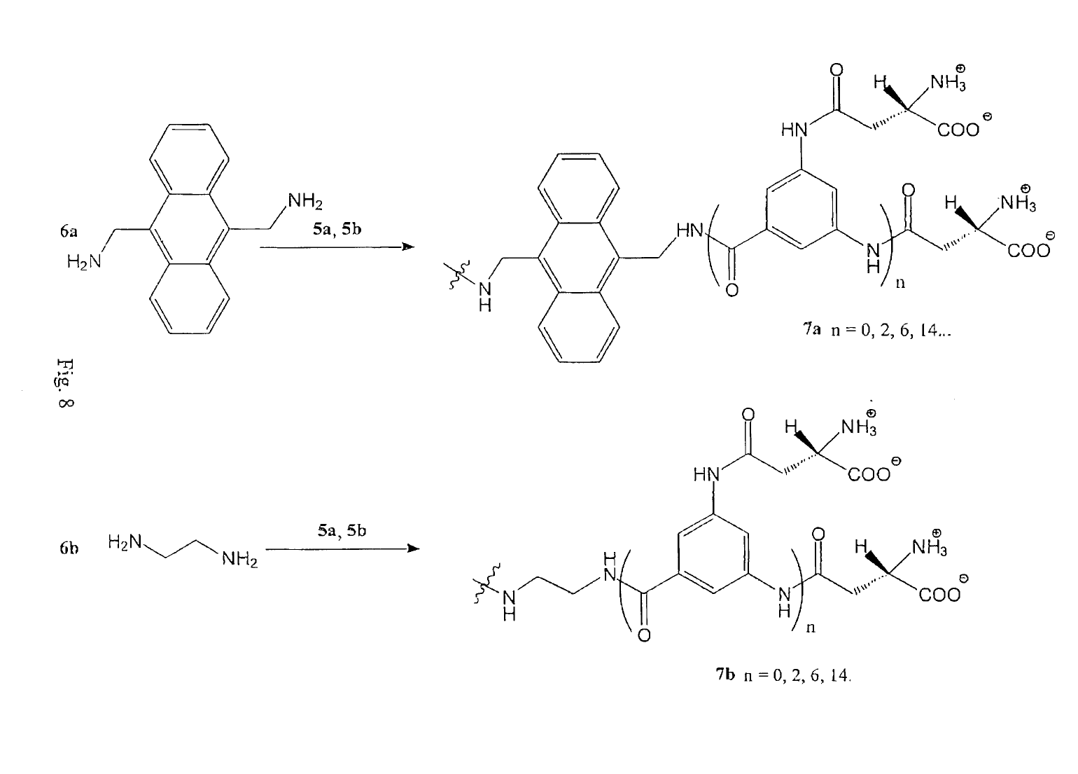

9,10-bis(aminomethyl)anthracene (6a in FIG. 8) was synthesized according to Gunnlaugsson et al. (Org. Lett., 2002: 4, 2449-2452) incorporated herein by reference.

Experimental Procedure

Synthesis of Dendrimer Structures Based on 3, 5-diamino-benzoic Acid

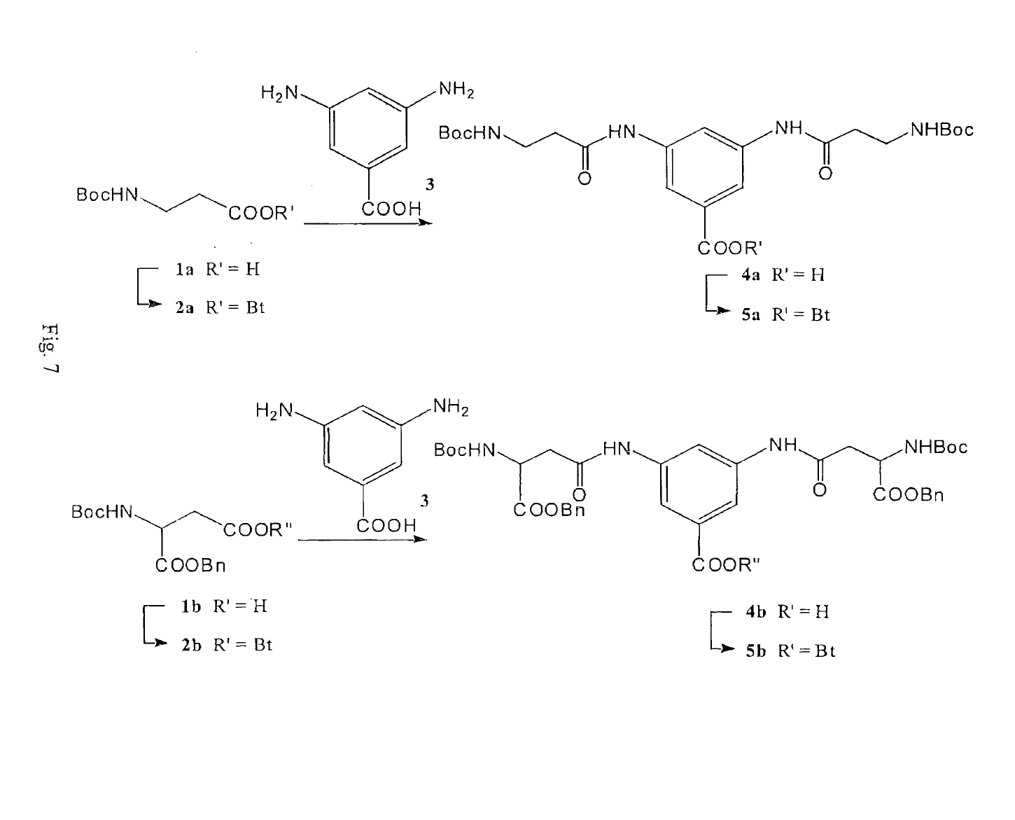

This section describes the synthesis of compounds 5a and 5b in FIG. 7 and the use of them as building block for marker compounds based on dendrimeric structures.

The two building blocks were synthesized by coupling commercially available amino acids to 3,5-diamino-benzoic acid as shown in FIG. 7. The building blocks were then activated as OBt-esters by treatment with DCC and HOBt to give 5a and 5b in FIG. 7.

The dendrimeric structures were then synthesized by coupling of building block 5a in FIG. 7 to a bisamine, as shown in 6a or 6b in FIG. 8. The protective groups were removed and the coupling, repeated.

Finally, building block 5b in FIG. 7 was coupled so as to give the protected dendrimer in FIG. 8. Deprotection gave a number of dendrimeric structures with different molecular weights according to structures 7a or 7b in FIG. 8.

Preparation of Building Blocks

Boc-β-Ala-OBt (2a)

Boc-β-Ala-OH 1a in FIG. 7, (1.0 g) was dissolved in DMF (20 mL) and HOBt (0.84 g) was added.

DCC (1.44 g) was added after 10 minutes. The mixture was stirred over night and then slowly added to ice cold water (250 mL).

The precipitate was collected and dried in vacuum and then dissolved in DCM (25 mL).

The slurry was then added to ice cold heptane (150 mL), stirred for two hours and then filtered to give compound 2a in FIG. 7 (1.13 g, 70% yield).

Boc-Asp(OBzl)-OBt (2b)

Boc-Asp(OBzl)-OH 1b in FIG. 7 was treated as in the synthesis of 2a in FIG. 7 to give Boc-Asp(OBzl)-OBt shown as 2b in FIG. 7.

3,5-di-(Boc-β-Ala)-Benzoic acid (4a)

3,5-diamino-benzoic acid shown as 3 in FIG. 7 (0.12 g) was dissolved in DMF (2 mL) and added to a slurry of 2a in FIG. 7 (0.58 mg) in DMF (5 mL).

DIPEA (1.3 mL) was added to the mixture. The mixture was stirred at 40° C. over night and then slowly added to ice cold water (100 mL) and acidified with citric acid (1.5 g). The precipitate was filtered off and dried in vacuum to give 4a in FIG. 7 in quantitative yield,

3,5-di-(Boc-β-Ala)-Benzoic Acid OBt Ester (5a)

Compound 4a in FIG. 7 (0.51 g) was dissolved in DMF (5 mL) and HOBt (0.16 g) and DCC (0.28 g) were added. The mixture was stirred over night, filtered and then slowly added to ice cold water (60 ml). The precipitate was filtered off and dried in vacuum to give 5a in FIG. 7 (75%).

3,5-di-(Boc-Asp(OBzl))-Benzoic Acid OBI Ester (5b)

3,5-diamino-benzoic acid was treated with 2b in FIG. 7 as in the synthesis of 5a described above,

General Procedure for Dendrimer Synthesis

a) Coupling

The diamine 6a or 6b in FIG. 8 (0.18 mmol) was dissolved in DMF (1.5 mL) and DIPEA (0.5 mL). A solution of the activated acid 5a in FIG. 8 and 1 (3.5 eq) in DMF (0.5 mL) was added and the mixture was stirred over night and then slowly added to ice cold water (100 mL). The precipitate was filtered off, dried in vacuum and then purified (SiO₂, DCM:MeOH 9:1, and Sephadex LH-20, DCM:MeOH 1:1).

b) Deprotection of Boc-Groups

The Boc groups were removed by addition of a TFA-solution (1 ml, TFA:DCM:anisole 80:15:5). The mixture was stirred for 2 hours and then concentrated twice with toluene.

c) Deprotection of Benzylesters:

The benzylesters were removed by treatment with aqeous NaOH (1 M, 0.5 mL) at 0° C. for 15 min and then neutralized using ice cold acetic acid. The mixture was then lyophilized.

d) Procedure to Synthesise, Higher Generations of Dendrimeric Structures

The procedures (a-b) were repeated to get higher generations, i.e. increase in molecular size, of dendrimeric structures. Finally compound 5b in FIG. 8 was coupled and deprotected using procedures b and c above. The final deprotected dendrimer was purified using reverse phase EPLC (MeCN: 0.1% aq TFA).

Results

The results of the synthesis are dendrimeric structures shown as 7a and 7b in FIG. 8.

### Example 2

This example describes without limiting the invention the synthesis of marker compounds from commercially available dendrimers for use as external landmarks external landmarks in 2D-gel electrophoresis.

Objective

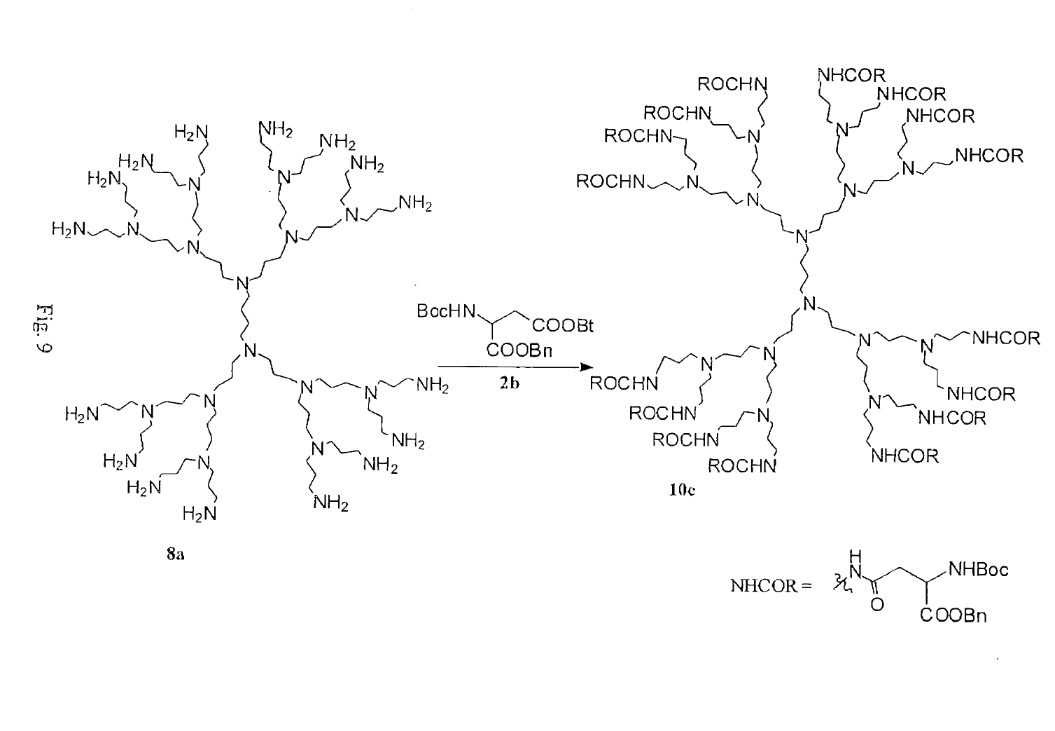

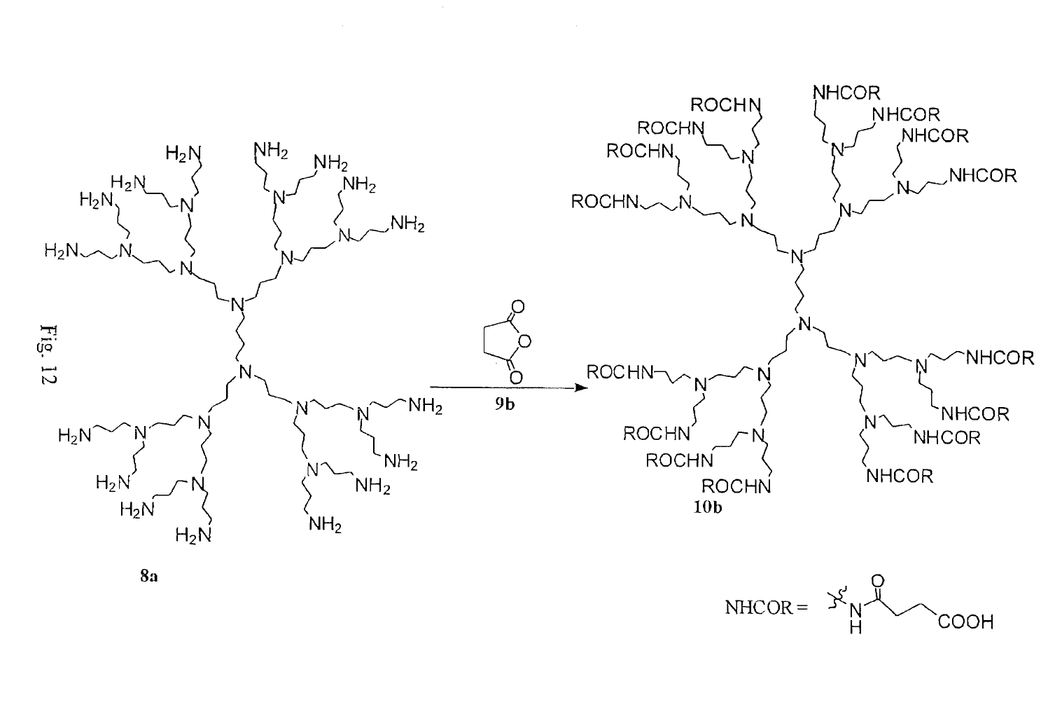

The objective of this example is to synthesize six different marker compounds with different pI (approximately 3-4 and 6-8) and molecular sizes (approximately 4000 and 16000). They are all synthesized from the two commercially available dendrimers DAB-Am 16 or DAB-Am-64. The dendrimers were condensed with three different acids to give six different landmarks as shown in FIGS. 9-14 as 10a, 10b, 10c, 11a, 11b, and 11c.

Material

DAB-Am 16 (Polypropylenimine hexadecaamine dendrimer, Generation 3.0) or DAB-Am-64 (Polypropylenimine tetrahexacontaamine dendrimer, Generation 5.0) are commercially available from Aldrich.

Experimental Procedure

Synthesis of 10c and 11c

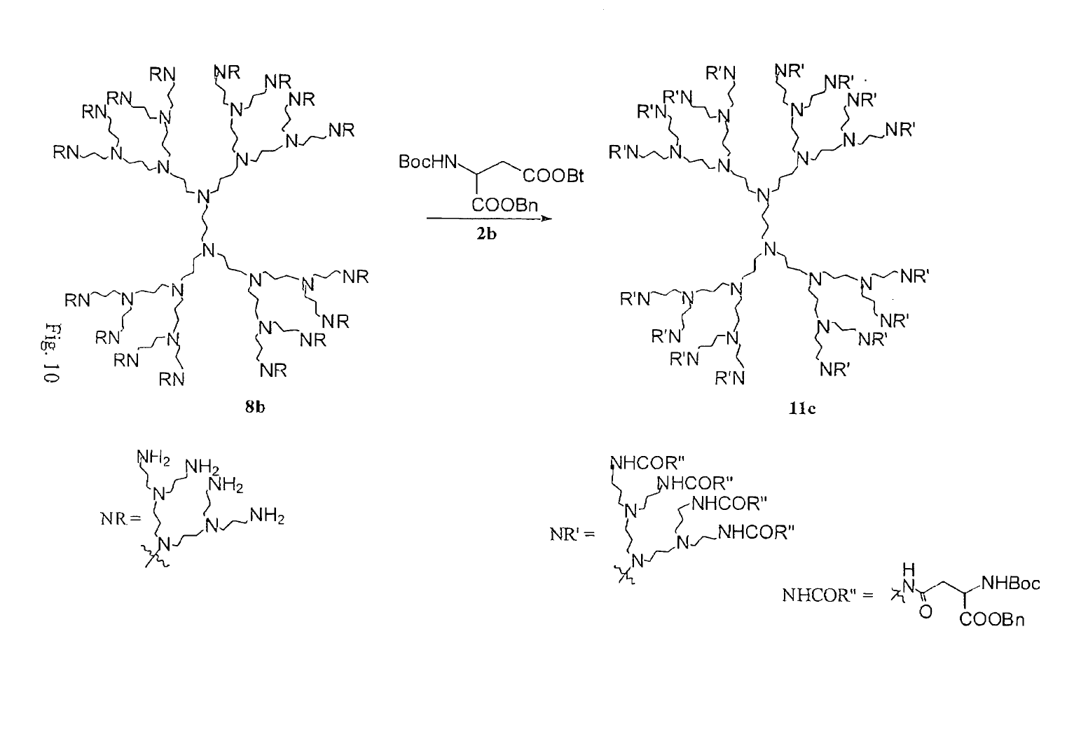

The synthesis of compound 10c and 11c are shown in FIGS. 9 and 10.

The dendrimers DAB-Am-16, 8a in FIG. 9, or DAB-Am-64, 8b in FIG. 10, (30 mg) were dissolved in a solution of activated Boc-Asp(OBzl)-OH shown as 2b in FIG. 9 (160 mg, 1.8 eq/NH,) in DMF (4 mL).

DIPEA (0.8 mL) was added and the mixtures were stirred over night and then slowly added to ice cold water (100 mL). The precipitate was dried in vacuum and then deprotected using procedures b and c in Experiment 1 above, and then purified using reverse phase HPLC (MeCN: 0.1% aq TFA).

Synthesis of 10a, 10b, 11a, and 11b

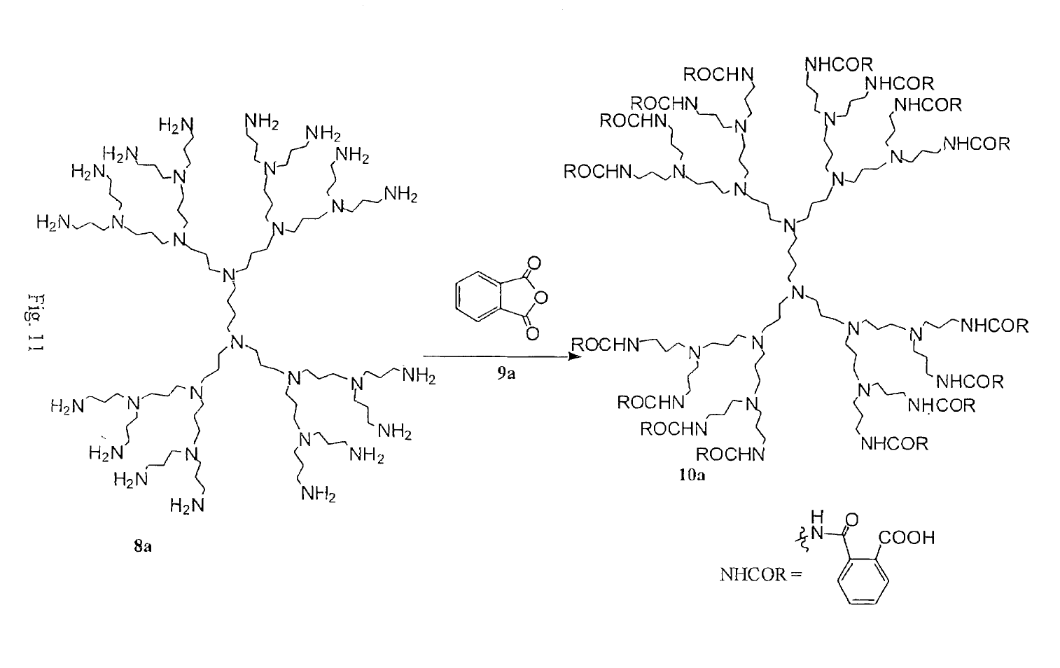

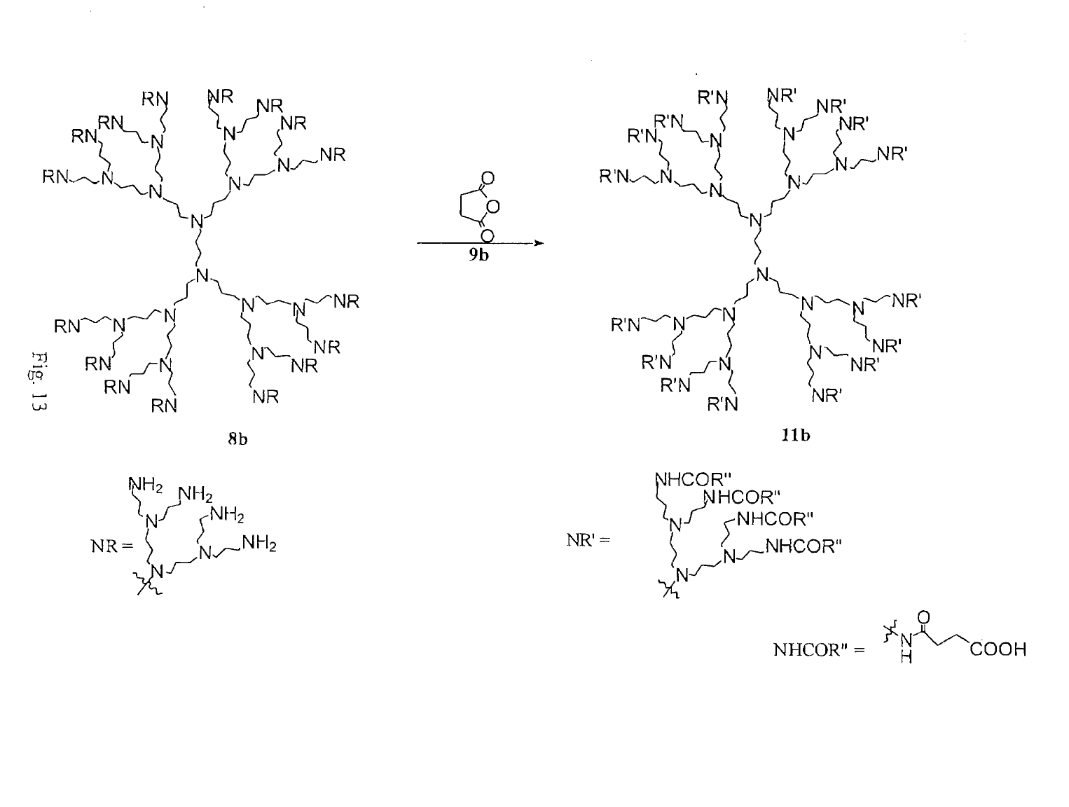

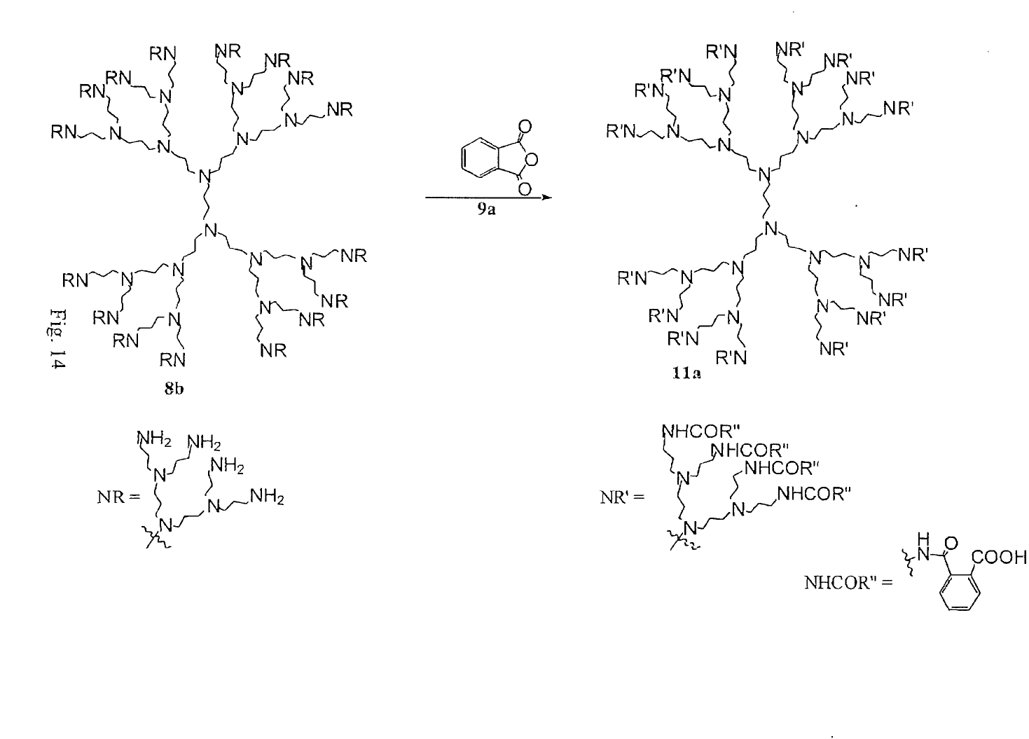

The synthesis of compound 10a, 10b, 11a, and 11b are shown in FIGS. 11-14. Another set of dendrimers was synthesized by coupling DAB-Am-16 shown as 8a in FIGS. 11-14, or DAB-Am-64 shown as 8b in FIG. 13 with succinic 9b in FIG. 13 or phthalic anhydride shown as 9a in FIG. 14 using the following procedure:

The dendrimer (38 mg) was dissolved in DMF (2 mL) and DIPEA (0.5 mL) and the anhydride shown as 9a or 9b in FIG. 11-14 (2 eq/NH₂) were added. The mixture was stirred over night and then concentrated and dried in vacuum. The residue was purified using reverse phase HPLC (MeCN: 0.1% aq TFA).

Results

The results of the synthesis are dendrimeric structures shown as 10a, 10b, 11a, and 11b in FIGS. 11-14.

### Example 3

This example describes without limiting the invention a two-dimensional gel electrophoresis with the addition of external dendrimer marker compounds.

Objective

The objective of this example is to position an external dendrimer marker in two dimensions in a polyacrylamid gel.

Material

Dendrimers synthesized in example 1 are used. The dendrimers G2 and G3 are shown in FIG. 8 as 7a where n=6 for G2 and n=14 for G3.

Experimental procedure

| | |
|---|---|
| Day 1—Rehydration | Sample molecules and the external |
| | dendrimer markers are dissolved in 125- |
| | 500 μl of 2 M thiourea, 7 M urea, |
| | 4% CHAPS, 0.3% DTT and 0.5% IPG |
| | buffert. The samples are pulled |
| | into the strip by diffusion over- |
| | night in a tray. |
| Day 2—1^{st} dimension | The strips are put onto the gel and |
| | aligned in a Multiphore. The proteins |
| | are focused for 10 h at 3500 V. |
| Day 3—2^{nd} dimension | Equilibrate the strips from day 2 |
| | in 30% glycerol, 2% SDS, 6 M urea |
| | and 50 mM Tris/HCL, supplemented with |
| | 65 mM DTT, and secondly 259 mM |
| | iodocetamine to reduce and alkylated the |
| | sample. Apply the strips to the gel and |
| | run the 2^{nd} dimension in a running |
| | buffer 0.1% SDS, 24 mM Tris-base and |
| | 0.2 M glycin for 20 h at 100 V. |
| Day 4—Staining and scanning | Fix the gel in 50% ethanol, 5% acetic |
| | acid, 45% water, milliQ quality, for 1 h. |
| | Wash in 50% ethanol and subsequently in |
| | water for 30 minutes each. A modified |
| | silver staining is performed to develop |
| | the gel, wherein the gel is sensitized |
| | in 0.02% sodium thiosulfate and stained |
| | with 0.1% silver nitrate. The gel is |
| | developed in 0.04% formaldehyde, 2% |
| | sodium carbonate till the samples are |
| | visualised enough for detection. The |
| | staining process is stopped by adding |
| | approximately 500 ml 5% acetic acid. |
| | The stained gels, both containing |
| | separated landmarks and sample |
| | molecules, are scanned in a scanner |
| | with dual detection possibility. The |
| | landmarks are detected in a separate |
| | image after a scanning step. enabling |
| | detection of the landmarks only. Without |
| | changing the position of the gel, the |
| | parameters are changed, so as to enable a |
| | separate scanning and detection of the |
| | separated sample molecules, i.e. the |
| | proteins. The two gel images, one with the |
| | separated landmarks and one with the |
| | separated sample proteins, now collected |
| | in digitalized form, are subsequently used |
| | for the image analysis of the gel. |

1. A marker compound suitable for gel electrophoresis, wherein the compound comprises at least one monomer unit, at least one functional group unit and optionally at least one core unit, and wherein the marker compound is characterised by a pI of about 1-12 and a Mw of about 100-10⁶ Da.

2. The marker compound according to claim 1, wherein the compound is characterised by a Mw of about 10³-10⁵ Da.

3 The marker compound according to any of claims 1 or 2, wherein the compound is characterised by a pI of about 3-10.

4. The marker compound according to any of claims 1-3, wherein the compound is a dendrimer.

5. The marker compound according to any of claims 1-4, wherein the compound is represented by the general formula
(core unit)ₙ(monomer unit_{1 .o})ₓ(functional group unit_{1 . . . p})
wherein n is an integer from 0-5 representing number of different co-existing optional cores,
wherein o is an integer from 2-1000 representing number of different monomers within the monomer unit distributed over x layers,
wherein x is an integer from 1-20 representing number of layers, and
wherein p is an integer from 1-20 representing the number of different functional groups within one functional group unit.

6. The marker compound according to any of claims 1-5, wherein the at least one core is selected from the group consisting of 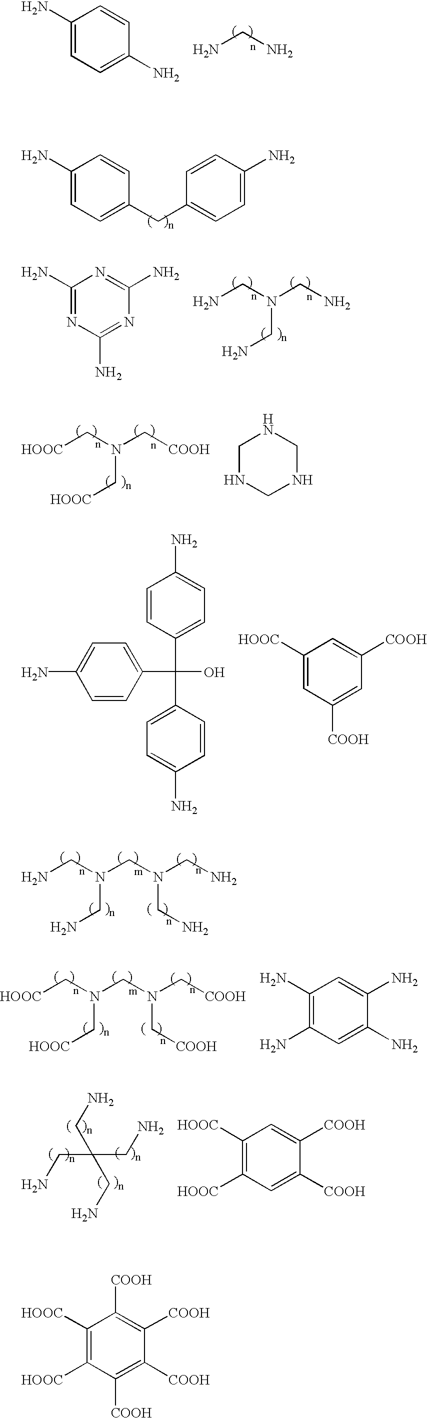
and mixtures thereof.

7. The marker compound according to claim 6, wherein the at least one core is a di-amine and/or a tri-amine.

8. The marker compound according to claim 7, wherein the di-amine or tri-amine is

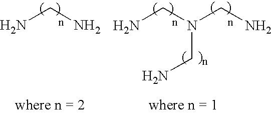

9. The marker compound according to any of claims 1-8, wherein the at least one monomer is selected from the group consisting of 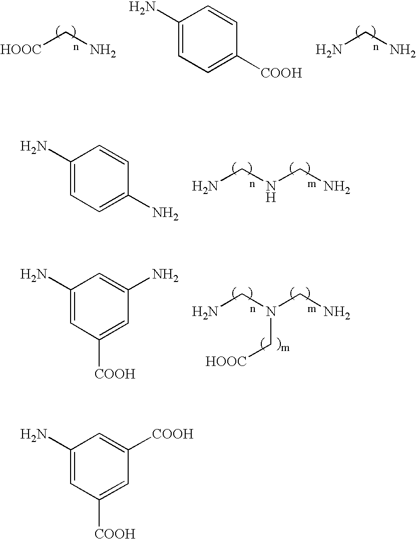
and mixtures thereof.

10. The marker compound according to claim 9, wherein the at least one monomer is diaminobenzoic acid.

11. The marker compound according to claim 10, wherein the diaminobenzoic acid monomer is distributed over 1-10 layer/s.

12. The marker compound according to any of claims 1-11, where in the at least one functional group is selected from the group consisting of amino acids or parts thereof; 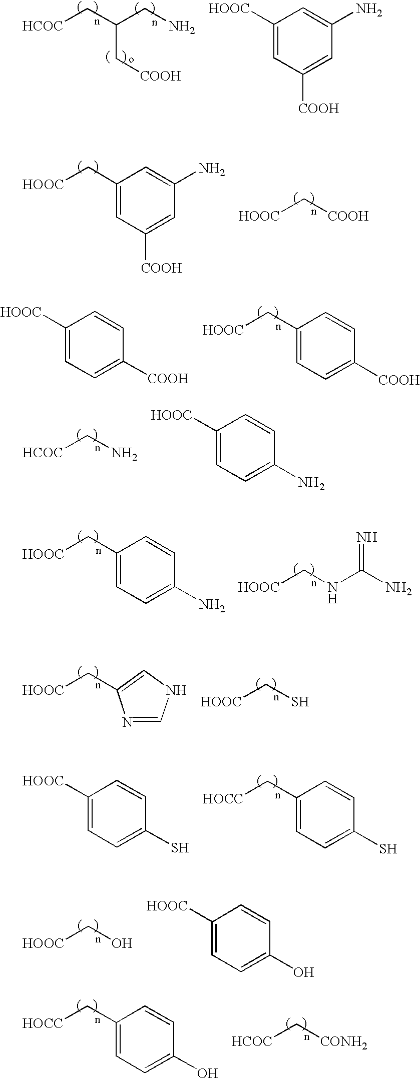
fluorochromes, such as fluorescamine; isotopes, and mixtures thereof.

13. The marker compound according to any of claims 1-12, wherein the compound has known characteristics affecting its migration in a gel during gel electrophoresis.

14. The marker compound according to claim 13, wherein the known characteristics are pI and molecular size.

15. A set of external markers suitable for gel electrophoresis comprising at least two of the marker compounds according to any of claims 1-14.

16. The set according to claim 15, wherein the set forms at least two marker spots in a gel.

17. The set according to claim 16, wherein the at least two marker spots form a grid on said gel, and wherein the grid is evenly distributed or unevenly distributed over the gel.

18. A kit of external markers comprising at least two of the marker compounds according to any of claims 1-14 or at least one of the sets according to any of claims 15-17, and optionally at least one buffer or buffer system.

19. The kit according to claim 18, wherein the at least two marker molecules or the set is to be dissolved upon usage or is pre-dissolved in a solution.

20. The kit according to any of claims 18-19, wherein at least one applicator strip suitable for gel electrophoresis is included.

21. Use of a marker compound according to any of claims 1-14 or at least one of the sets according to any of claims 15-17 for detection and/or quantification of a sample or sample molecule.

22. Use according to claim 21, wherein the detection and/or quantification of a sample or sample molecule is dependent on the pI and molecular size of the marker compound.

23. A method for determining and/or verifying the characteristics of a marker compound according to any of claims 1-14, or a set of external landmarks according any of claims 15-17 comprising the steps of
a) preselecting a theoretic positions where a marker compound according to the invention or a set of external landmarks according to the invention is to position,
b) designing a marker compound according to the invention or a set of external landmarks according to the invention so as to achieve correct characteristics,
c) applying the marker compound or the set in b) above onto the gel,
d) separating the marker compound or the set in c) in a first dimension,
e) optionally separating the marker compound or set in a second or further dimension.
f) collecting information about the separation in d) and optionally in e),
g) registrating the information in f) as digital information, and
h) determining and/or verifying the characteristics after separation.

24. The method according to claim 23, wherein the application of the set in step d) above includes applying the set in the form of application strips or mixing and applying the set together with the test samples or applying the set at the time of casting of the gel.

25. The method according to claim 23, wherein the optional separation in step e) above is a separation in a second dimension.

26. The method according to claim 23, wherein the separation is in a first and a second dimension, and wherein the first and second dimension is dependent on pI and molecular size of the marker compound.

27. The method according to any of claims 23-26, wherein the collecting information about the position in step f) above is done by using any of the determination processes selected from the group consisting of visual light, V, IR, multispectral imaging, isotope labelling, colouring techniques, e.g. silver staining, Comassie staining; fluorescence. e.g. fluorochromes such as fluorescamine and mixtures thereof.

28. A method for detection and/or quantification of a sample and/or external landmark in a gel comprising the steps of
a) adding the sample to the gel
b) adding the at least two marker compounds according to any of claims 1-14, or the at least one set according to any of claims 15-17, with known identity and known characteristics on the gel,
c) separating said sample or marker compound in b) above to form, with said at least two marker compounds or set of external landmarks added, an array of spots of the sample proteins and at least two of the marker molecules or at least one of the sets, respectively.
d) collecting information about the positions of the array of spots in at least one image and optionally superimposing the images,
e) registrating the information in d) above as digital data, and
f) analysing and/or correcting and optionally changing the image or images to detect, quantify and optionally verify the sample.

29. The method according to claim 28, wherein the adding in step a) and/or b) above includes adding the sample and/or the at least two of the marker compounds or the at least one set in application strips, or wherein the adding includes mixing and applying the at least one set or the at least two marker molecules together with the test samples or applying the at least one set or the at least two marker molecules at the time of casting the gel.

30. The method according to claim 29, wherein the separation in step c) above is performed in at least two dimensions and the array formed in step c) above is an array in at least two dimensions.

31. The method according to claim 30, wherein the separation in two dimensions is a two-dimensional gel-electrophoresis, and wherein the gel-electrophoresis is a polyacrylamide gel-electrophoresis, and wherein the two dimension are dependent on pI and molecular size.

32. The method according to claim 28, wherein the analysing in step f) above includes correlating the sample to the at least two marker molecules or the at least one set with known positions and characteristics, and optionally correcting for background noise and distortions, and assigning the sample at least one characteristic.

33. The method according to claim 28, wherein the known characteristics of said at least two marker molecules or the at least one set are dependent on their molecular sizes, and step f) in claim 28 above further comprises assigning a molecular size to at least one sample based on the molecular size of said set of external landmarks.

34. The method according to claim 28, wherein the known characteristics of said at least two marker molecules or the at least one set are dependent on their pI, and step f) in claim 28 above further comprises assigning a pI to at least one sample based on the pI of said set of external landmarks.

35. The method according to claim 28, wherein the known characteristics of said set of external landmarks are dependent on their molecular sizes and their pI, and step f) in claim 28 further comprises assigning a molecular size and a pI to at least one sample based on the molecular size and the pI of said set of external landmarks.
